(19) United States
(12) Patent Application Publication
(10) Pub. No.: US 2018/0069204 A1
(43) Pub. Date: Mar. 8, 2018

(54) PACKAGING MATERIAL FOR POWER STORAGE DEVICE

(71) Applicant: TOPPAN PRINTING CO., LTD., Tokyo (JP)

(72) Inventor: Mina SATO, Tokyo (JP)

(73) Assignee: TOPPAN PRINTING CO., LTD., Tokyo (JP)

(21) Appl. No.: 15/791,490

(22) Filed: Oct. 24, 2017

Related U.S. Application Data
(63) Continuation of application No. PCT/JP2016/062420, filed on Apr. 19, 2016.

(30) Foreign Application Priority Data
Apr. 28, 2015 (JP) 2015-091770

(51) Int. Cl. H01M 2/02

(52) U.S. Cl. CPC H01M 2/0287; H01M 2/0277; H01M 2/0285

(57) ABSTRACT

A packaging material for a power storage device, including: a metal foil layer; a coating layer formed on a first surface of the metal foil layer; an anti-corrosion treatment layer formed on a second surface of the metal foil layer; an adhesive layer formed on the anti-corrosion treatment layer; and a sealant layer formed on the adhesive layer, wherein the coating layer contains at least one material selected from a group consisting of a fluorine-based resin, a polyester resin, and a polyurethane resin, and the coating layer contains 1 to 30 mass % of a pigment.

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Application No. PCT/JP2016/062420, filed on Apr. 19, 2016, which is based upon and claims the benefit of priority of Japanese Patent Application No. 2015-091770, filed on Apr. 28, 2015, the entireties of which are hereby incorporated by reference.

### TECHNICAL FIELD

The present invention relates to a packaging material for a power storage device.

### BACKGROUND

Nickel metal hydride storage batteries and lead storage batteries have been known to be used as power storage devices such as secondary batteries. In many cases, these power storage devices are required to be small-sized due to downsizing of mobile devices, limitations of installation space, and the like. Accordingly, attention is being paid to lithium ion batteries, having higher energy density. As a packaging material (hereinafter, also referred to simply as a “packaging material”) used for a lithium ion battery, a metallic can has been widely used; however a multilayer film that is light, has higher radiation performance, and can be produced at low cost has come to be increasingly used.

An electrolytic solution of the lithium ion battery is composed of an electrolyte and an aprotic solvent such as propylene carbonate, ethylene carbonate, dimethyl carbonate, diethyl carbonate, or ethylmethyl carbonate. As the electrolyte, a lithium salt such as LiPF₆ or LiBF₄ is used. However, such a lithium salt generates hydrofluoric acid due to a hydrolysis reaction with moisture. The hydrofluoric acid may cause corrosion of a metal surface of a battery member or reduction in laminate bond strength between layers of a packaging material made of a multilayer film.

In view of this, a barrier layer made of an aluminum foil or the like is provided inside the packaging material made of a multilayer film so that moisture is prevented from entering from a surface of the multilayer film. For example, a packaging material has been known in which a substrate layer having heat resistance, a first adhesive layer, a barrier layer, an anti-corrosion treatment layer preventing corrosion due to hydrofluoric acid, a second adhesive layer, and a sealant layer are sequentially laminated. A lithium ion battery which uses such a packaging material is also referred to as an aluminum laminate type lithium ion battery.

There is a lithium ion battery which is known as a type of the aluminum laminate type lithium ion battery. In the lithium ion battery, a recess is formed on a part of a packaging material by cold forming, and battery contents such as a positive electrode, a separator, a negative electrode, and an electrolytic solution are housed in the recess, and the remaining portions of the packaging material are folded back and edges of the packaging material are sealed by heat sealing. Such a lithium ion battery is also referred to as an embossed type lithium ion battery. In recent years, an embossed type lithium ion battery having recess on both sides of a packaging material to be bonded to each other has been produced. This type of lithium ion battery can house more battery contents.

The energy density of the lithium ion battery increases as the depth of the recess formed by cold forming increases. However, as a deeper recess is formed, pinholes or breakage are more likely to occur when a packaging material is formed. Thus, a stretched film is used for a substrate layer of the packaging material in order to protect a metal foil. As described above, the substrate layer is normally bonded to a barrier layer via an adhesive layer (see, for example, PTL 1).

### Citation List

### Patent Literature

PTL 1: JP-3567230 B

### SUMMARY OF THE INVENTION

### Technical Problem

In order to improve formability, a technique of PTL 1 uses a stretched polyamide film or stretched polyester film as the base layer having tensile strength and elongation amount set to a predetermined value or more. In the case where the stretched polyamide film is used, however, there is a problem that the stretched polyamide film is dissolved when an electrolytic solution is adhered to the stretched polyamide film, for example, in a step of injecting an electrolytic solution.

A packaging material of PTL 1 has insufficient scratch resistance to scratches made during transportation or the like.

According to the packaging material of PTL 1, the packaging material has an appearance in a metal foil color. Thus, in the case where pinholes occur in a substrate or a metal foil, it is difficult to detect the pinholes.

The technique of PTL 1 requires an adhesive layer for adhering a stretched film to a barrier layer. Accordingly, there is a limit to reduction in cost and thickness of the packaging material.

In view of this, an object of the present invention is to provide a packaging material for a power storage device, which has higher electrolyte resistance, scratch resistance, ease of pinhole detection, and insulation properties and reduces film thickness.

### Solution to Problem

The present invention provides a packaging material for a power storage device, the packaging material including: a metal foil layer; a coating layer formed on a first surface of the metal foil layer; an anti-corrosion treatment layer formed on a second surface of the metal foil layer; an adhesive layer formed on the anti-corrosion treatment layer; and a sealant layer formed on the adhesive layer, wherein the coating layer contains at least one material selected from a group consisting of a fluorine-based resin, a polyester resin, and a polyurethane resin, and the coating layer contains 1 to 30 mass % of a pigment.

The present invention is preferably configured such that the pigment is at least one material selected from a group consisting of an inorganic pigment and an organic pigment.

The present invention is preferably configured such that the coating layer has a thickness of 3 to 30 μm.

The present invention is preferably configured such that the coating layer has been cured.

The present invention is preferably configured such that the coating layer is formed by coating.

### Advantageous Effects of the Invention

According to the present invention, a packaging material is provided for a power storage device, which has higher electrolyte resistance, scratch resistance, ease of detection of pinholes, and insulation properties, and enables reduction in film thickness. Specifically, since the predetermined coating layer is provided, an outer surface is unlikely to be deteriorated even when an electrolytic solution is adhered thereto. Furthermore, since the content of pigment in the coating layer is set to the predetermined amount, higher scratch resistance and easy detection of pinholes are achieved while preventing degradation of insulation properties. Further, since the coating layer is formed directly on the metal foil layer, no adhesive layer needs to be provided, and this makes it possible to reduce film thickness.

### BRIEF DESCRIPTION OF THE DRAWINGS

FIG. 1 is a cross-sectional view illustrating a packaging material for a power storage device according to an embodiment of the present invention.

### DESCRIPTION OF REPRESENTATIVE EMBODIMENTS

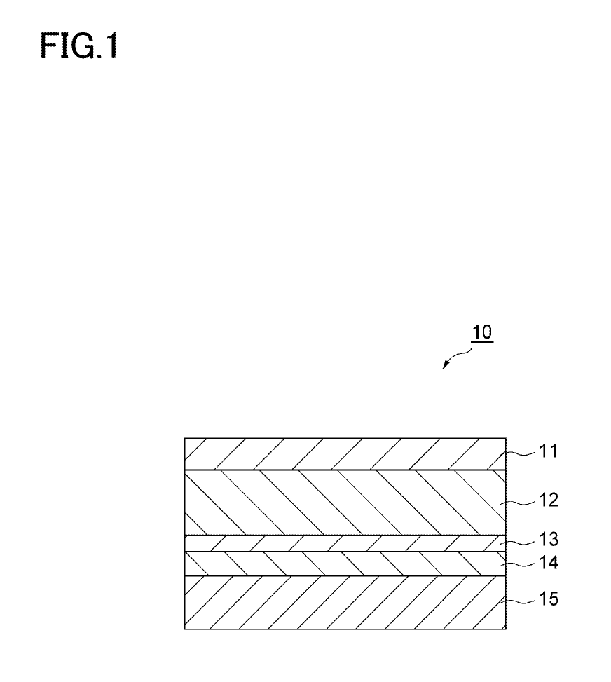

With reference to FIG. 1, a representative embodiment of the present invention will be described. FIG. 1 is a cross-sectional view illustrating a packaging material for a power storage device (hereinafter simply referred to as a “packaging material”) 10 of the present embodiment.

As illustrated in FIG. 1, a packaging material 10 has a metal foil layer 12 which provides a barrier function, a coating layer 11 formed on a first surface of the metal foil layer 12, an anti-corrosion treatment layer 13 formed on a second surface of the metal foil layer 12, and an adhesive layer 14 and a sealant layer 15 sequentially laminated on the anti-corrosion treatment layer 13. In the case where a power storage device is formed with use of the packaging material 10, the coating layer 11 is an outermost layer and the sealant layer 15 is an innermost layer.

[Coating Layer]

The coating layer 11 prevents the occurrence of pinholes in the metal foil layer 12 which may be caused during processing or distribution of a power storage device. Further, the coating layer 11 has heat resistance so as to be able to withstand a sealing step during production. The coating layer 11 is made of resin and is directly formed on the first surface of the metal foil layer 12, not via an adhesive or the like. Such a coating layer can be formed by applying, to a metal foil layer, a resin material which is to be the coating layer.

The resin material for forming the coating layer 11 is preferably a fluorine-based resin, a polyester resin, or a polyurethane resin. That is, the coating layer 11 contains at least one material selected from a group consisting of a fluorine-based resin, a polyester resin, and a polyurethane resin. This is because a fluorine-based resin, polyester resin, and polyurethane resin have higher electrolyte resistance and can maintain insulation properties even under higher humidity.

The fluorine-based resin for forming the coating layer 11 can include polytetrafluoroethylene, polychlorotrifluoroethylene, polyvinylidene fluoride, polyvinyl fluoride, perfluoroalkoxy fluororesin, a tetrafluoroethylene-hexafluoropropylene copolymer, an ethylene-tetrafluoroethylene copolymer, an ethylene-chlorotrifluoroethylene copolymer, or the like. In particular, a tetrafluoride type fluororesin which has a stable structure and higher insulation properties under high humidity is preferable, and a tetrafluoroethylene-vinyl copolymer having solvent solubility is more preferable. Furthermore, the fluorine-based resin has preferably been cured by isocyanate. In the case where the fluorine-based resin has been cured by isocyanate, it is possible to improve heat resistance of a coating film and ensure insulation properties under high humidity due to a dense crosslinked structure.

The isocyanate to be added to the fluorine-based resin for forming the coating layer 11 can include methyl isocyanate, diphenylmethane diisocyanate, hexamethylene diisocyanate, tolylene diisocyanate, isophorone diisocyanate, xylylene diisocyanate, or the like. In particular, the isocyanate preferably contains tolylene diisocyanate capable of increasing strength of a coating film, and ensuring insulation properties under high humidity.

The polyester resin for forming the coating layer 11 that can be suitably used include a polyester resin obtained by reaction of polyhydric alcohol with polybasic acid. Examples of the polyhydric alcohol include, but are not limited to, ethylene glycol, propylene glycol, 1,3-butylene glycol, 1,6-hexanediol, diethylene glycol, dipropylene glycol, neopentyl glycol, triethylene glycol, hydrogenated bisphenol A, bisphenol dihydroxy propyl ether, 3-methylpentanediol, 2,2,4-trimethyl-1, 3-pentanediol, 1,4-cyclohexanedimethanol, spiroglycol, glycerin, trimethylolethane, trimethylolpropane, tris(hydroxymethyl)aminomethane, tris-(2-hydroxyethyl)isocyanurate, pentaerythritol, and dipentaerythritol.

Examples of the polybasic acid include, but are not limited to, benzoic acid, p-tertiary-butyl-benzoic acid, phthalic anhydride, isophthalic acid, terephthalic acid, succinic anhydride, adipic acid, azelaic acid, sebacic acid, tetrahydrophthalic anhydride, hexahydrophthalic anhydride, 1,4-cyclohexane dicarboxylic acid, tetrabromophthalic anhydride, tetrachlorophthalic anhydride, HET anhydride, himic anhydride, maleic anhydride, fumaric acid, itaconic acid, trimellitic anhydride, methyl cyclohexene tricarboxylic acid anhydride, and pyromellitic anhydride.

The polyester resin for forming the coating layer 11 may be a polyester resin which has been modified or cured. Examples of a material which modifies the polyester resin for forming the coating layer 11 include a fatty acid, a phenolic resin, an acrylic resin, and an epoxy resin.

Examples of a material which cures the polyester resin for forming the coating layer 11 include melamine, amine, and isocyanate. As the isocyanate among these, it is possible to use isocyanate similar to the isocyanate which is added to the fluorine-based resin.

The polyurethane resin for forming the coating layer 11 that can be suitably used include a polyurethane resin obtained by reaction of polyisocyanate with polyol.

Examples of the polyisocyanate include, but are not limited to, a compound obtained by isocyanurate-modifying an aliphatic polyisocyanate compound, an alicyclic polyisocyanate compound, an aromatic polyisocyanate compound, an araliphatic polyisocyanate compound, or the like. Examples of the aliphatic polyisocyanate compound include, but are not limited to, tetramethylene diisocyanate, dodecamethylene diisocyanate, hexamethylene diisocyanate, 2,2,4-trimethyl hexamethylene diisocyanate, 2,4,4-trimethyl hexamethylene diisocyanate, lysine diisocyanate, 2-methylpentane-1, 5-diisocyanate, and 3-methylpentane-1, 5-diisocyanate. Examples of the alicyclic polyisocyanate compound include, but are not limited to, isophorone diisocyanate, hydrogenated xylylene diisocyanate, 4,4′-dicyclohexylmethane diisocyanate, 1,4-cyclohexane diisocyanate, methylcyclohexylene diisocyanate, and 1,3-bis(isocyanatomethyl)cyclohexane. Examples of the aromatic polyisocyanate compound include, but are not limited to, tolylene diisocyanate, 2,2′-diphenylmethane diisocyanate, 2,4′-diphenylmethane diisocyanate, 4,4′-diphenylmethane diisocyanate (MDI), 4,4′-dibenzyl diisocyanate, 1,5-naphthylene diisocyanate, xylylene diisocyanate, 1,3-phenylene diisocyanate, and 1,4-phenylene diisocyanate. Examples of the araliphatic polyisocyanate compound include, but are not limited to, dialkyl diphenylmethane diisocyanate, tetraalkyl diphenylmethane diisocyanate, and α,α,α,α-tetramethyl xylylene diisocyanate.

Examples of the polyol include, but are not limited to, ethylene glycol, 1,3-propanediol, 1,2-propanediol, 2-methyl-1, 3-propanediol, 1,4-butanediol, 1,3-butanediol, 1,4-pentanediol, 1,5-pentanediol, 1,6-hexanediol, 1,5-hexanediol, 1,2-hexanediol, 2,5-hexanediol, octanediol, nonanediol, decanediol, diethylene glycol, triethylene glycol, dipropylene glycol, cyclohexanediol, trimethylolpropane, glycerin, 2-methylpropan-1, 2,3-triol, 1,2,6-hexanetriol, pentaerythritol, polylactone diol, polylactone triol, ester glycol, polyester polyol, polyether polyol, polycarbonate polyol, polybutadiene polyol, acrylic polyol, silicone polyol, fluoropolyol, polytetramethylene glycol, polypropylene glycol, polyethylene glycol, polycaprolactone polyol, castor oil-based polyol, and dimer-acid-based polyol.

The polyurethane resin for forming the coating layer 11 may be a polyurethane resin which has been modified or cured. A material which modifies the polyurethane resin for forming the coating layer 11 may be any material which can be introduced into the polyurethane resin, and is not particularly limited. Examples of a material which cures the polyurethane resin for forming the coating layer 11 include isocyanate, and it is possible to use isocyanate similar to the isocyanate which is added to the fluorine-based resin.

The coating layer 11 preferably has a thickness of 3 to 30 μm, and more preferably of 5 to 20 μm. In the case where the coating layer 11 has a thickness of less than 3 μm, it is difficult to ensure insulation properties. Meanwhile, the coating layer 11 with a thickness of more than 30 μm does not have improved properties and merely reduces space for battery contents to be housed. Since the coating layer 11 is formed directly on the metal foil layer 12, it is easy to make the configuration of the packaging material 10 thinner than that of a conventional packaging material, by causing the coating layer to have a thickness of not more than 20 μm.

The coating layer 11 contains a pigment. According to the present embodiment, the pigment is preferably at least one material selected from a group consisting of an inorganic pigment and an organic pigment. Examples of the inorganic pigment include, but are not limited to, a titanium black pigment, a carbon black pigment, an oxide pigment, a hydroxide pigment, a sulfide pigment, a chromate pigment, a silicate pigment, a sulfate pigment, and a carbonate pigment. Examples of the organic pigment include, but are not limited to, a textile printing pigment, an azo pigment, a phthalocyanine pigment, a condensed polycyclic pigment, a nitro pigment, a nitroso pigment, and a day/night fluorescent pigment. Furthermore, it is also possible to use, for example, a filler containing a pigment. The size of the pigment is not particularly limited, but from the viewpoint of colorability, the pigment preferably has an average particle size of 0.5 to 3 μm.

The content of the pigment in the coating layer 11 is preferably 1 to 30 mass % and more preferably 3 to 10 mass %, based on a total mass of the coating layer 11. In the case where the content of the pigment is less than 1 mass %, detection of pinholes becomes difficult and scratch resistance is deteriorated. In the case where the content of the pigment is more than 30 mass %, insulation properties are deteriorated.

[Metal Foil Layer]

The metal foil layer 12 can include various metal foils such as an aluminum foil and a stainless steel foil. From the viewpoint of humidity resistance, processability such as ductility and malleability, and cost, an aluminum foil is preferable. As the aluminum foil, a generally-used soft aluminum foil can be used. Among them, an aluminum foil containing iron is preferable because of having higher pinhole resistance and higher ductility and malleability in forming.

The content of iron in the aluminum foil (100 mass %) containing iron is preferably not less than 0.1 mass % and not more than 9.0 mass %, and more preferably not less than 0.5 mass % and not more than 2.0 mass %. In the case where the content of iron is not less than 0.1 mass %, the packaging material 10 has higher pinhole resistance and higher ductility and malleability. In the case where the content of iron is not less than 9.0 mass %, the packaging material 10 has higher flexibility.

From the view point of barrier properties, pinhole resistance, and processability, the metal foil layer 12 preferably has a thickness of 9 to 200 μm, and more preferably of 15 to 100 μm.

[Anti-Corrosion Treatment Layer]

The anti-corrosion treatment layer 13 prevents corrosion of the metal foil layer 12 caused by an electrolytic solution or hydrofluoric acid generated by reaction of an electrolytic solution with moisture. The anti-corrosion treatment layer 13 also improves adhesion between the metal foil layer 12 and the adhesive layer 14.

The anti-corrosion treatment layer 13 is preferably formed of a coating- or immersion-type acid-resistant anti-corrosion prevention treatment agent. Such an anti-corrosion treatment layer has higher effects of preventing corrosion of the metal foil layer 12 due to acid.

Examples of the coating film constituting the anti-corrosion treatment layer 13 include a coating film which is formed by ceria sol treatment using an anti-corrosion treatment agent consisting of cerium oxide, phosphate, and various thermosetting resins, and a coating film which is formed by chromate treatment using an anti-corrosion treatment agent consisting of chromate, phosphate, fluoride, and various thermosetting resins.

The anti-corrosion treatment layer 13 is not limited to the aforementioned coating film as long as the metal foil layer 12 can have sufficient corrosion resistance. For example, the anti-corrosion treatment layer 13 may be a coating film formed by phosphate treatment, boehmite treatment, or the like.

The anti-corrosion treatment layer 13 may be a monolayer or a multilayer. Furthermore, the anti-corrosion treatment layer 13 may contain an additive such as a silane-based coupling agent.

From the viewpoint of a corrosion prevention function and an anchoring function, the anti-corrosion treatment layer 13 preferably has a thickness of 10 nm to 5 μm, and more preferably of 20 nm to 500 nm.

The anti-corrosion treatment layer 13 may be further provided between the coating layer 11 and the metal foil layer 12 in accordance with a required function.

[Adhesive Layer]

The adhesive layer 14 adheres the sealant layer 15 to the metal foil layer 12 on which the anti-corrosion treatment layer 13 is formed. Depending on an adhesive component forming the adhesive layer 14, the packaging material 10 is categorized into two configurations: a packaging material with a thermal lamination configuration and a packaging material with a dry lamination configuration.

The adhesive component for forming the adhesive layer 14 in the thermal lamination configuration is preferably an acid-modified polyolefin-based resin obtained by graft-modifying a polyolefin-based resin with acid such as maleic anhydride. The acid-modified polyolefin-based resin has a polar group which is introduced into a part of the polyolefin-based resin which is nonpolar. Thus, even in the case where the sealant layer 15, which is nonpolar, is formed of a polyolefin-based resin film or the like and the anti-corrosion treatment layer 13 is formed by a layer having a polarity, the adhesive layer 14 can firmly be adhered to both of the sealant layer 15 and the anti-corrosion treatment layer 13. Furthermore, use of the acid-modified polyolefin-based resin improves resistance to contents such as an electrolytic solution, and even in the case where hydrofluoric acid is generated in the battery, it is easy to prevent a decrease in adhesion due to deterioration of the adhesive layer 14.

The acid-modified polyolefin-based resin used for the adhesive layer 14 may be used alone or in combination of two or more.

Examples of the polyolefin-based resin used for the acid-modified polyolefin-based resin include: low-density polyethylene, medium-density polyethylene, and high-density polyethylene; an ethylene-α-olefin copolymer; homo polypropylene, block polypropylene, or random polypropylene; and a propylene-α-olefin copolymer. The polyolefin resin may be a copolymer obtained by copolymerizing the aforementioned material with a polar molecule such as acrylic acid or methacrylic acid, a polymer such as crosslinked polyolefin, or the like.

The acid which modifies the polyolefin-based resin may be carboxylic acid, an epoxy compound, or acid anhydride, and maleic anhydride is preferable.

Examples of the adhesive component of the adhesive layer 14 in the dry lamination configuration include a two-part curable polyurethane-based adhesive. In this case, the adhesive layer 14 in the dry lamination configuration has a highly hydrolysable binding site, such as an ester group or a urethane group. Accordingly, the adhesive layer 14 in the thermal lamination configuration is preferable for applications requiring higher reliability.

[Sealant Layer]

The sealant layer 15 imparts sealability to the packaging material 10 by heat sealing. The sealant layer 15 may be a resin film made of a polyolefin-based resin or an acid-modified polyolefin-based resin obtained by graft-modifying a polyolefin-based resin with acid such as maleic anhydride.

Examples of the polyolefin-based resin include: low-density polyethylene, medium-density polyethylene, and high-density polyethylene; an ethylene-α-olefin copolymer; homo polypropylene, block polypropylene, or random polypropylene; and a propylene-α-olefin copolymer. Those polyolefin-based resins may be used alone or in combination of two or more.

Examples of the acid which modifies the polyolefin-based resin include those listed above in connection with the description of the adhesive layer 14.

The sealant layer 15 may be a monolayer film or a multilayer film, which may be selected depending on the desired properties. For example, in order to provide d, it is possible to use a multilayer film in which a resin such as an ethylene-cycloolefin copolymer or polymethylpentene, is provided between layers.

Moreover, the sealant layer 15 may be formulated with various additives such as a flame retardant, a slip agent, an anti-blocking agent, an antioxidant, a light stabilizer, and a tackifier.

The sealant layer 15 preferably has a thickness of 10 to 100 μm, and more preferably of 20 to 60 μm.

The packaging material 10 may include the sealant layer 15 laminated by dry lamination. From the viewpoint of improving adhesion, however, the packaging material 10 is preferably configured such that the sealant layer 15 is laminated by sandwich lamination or co-extrusion, using an acid-modified polyolefin-based resin as the adhesive layer 14.

[Production Method]

A method of producing the packaging material 10 will be described. Specifically, a method including the following steps (1) to (3) can be used as the method of producing the packaging material 10. However, the method described below is an example, and the method of producing the packaging material 10 is not limited thereto.

Step 1: A step of forming the anti-corrosion treatment layer 13 on one surface (second surface) of the metal foil layer 12

Step 2: A step of forming the coating layer 11 by placing a resin material for a coating layer on a surface (first surface) opposite to the second surface of the metal foil layer 12.

Step 3: A step of bonding the sealant layer 15 to the anti-corrosion treatment layer 13, which is formed on the metal foil layer 12, via the adhesive layer 14.

(Step 1)

An anti-corrosion treatment agent is applied to one surface of the metal foil layer 12 and is dried to thereby form the anti-corrosion treatment layer 13. Examples of the anti-corrosion treatment agent include the aforementioned anti-corrosion treatment agent for ceria sol treatment and anti-corrosion treatment agent for chromate treatment. The method of applying the anti-corrosion treatment agent is not particularly limited, and various methods such as gravure coating, reverse coating, roll coating, and bar coating can be used.

(Step 2)

A resin material which is to be a coating layer is applied to the first surface of the metal foil layer 12 and is dried to thereby form the coating layer 11 on the first surface. The method of applying the resin material is not particularly limited, and various methods such as gravure coating, reverse coating, roll coating, and bar coating can be used. After coating, curing is accelerated, for example, by aging treatment at 60° C. for 7 days.

(Step 3)

In a laminated body in which the coating layer 11, the metal foil layer 12, and the anti-corrosion treatment layer 13 are laminated in this order, the adhesive layer 14 is formed on the anti-corrosion treatment layer 13, and a resin film for forming the sealant layer 15 is bonded to the adhesive layer 14. The sealant layer 15 is preferably laminated by sandwich lamination.

The packaging material 10 is obtained by the Steps (1) to (3) described above. The order of the steps in the method of producing the packaging material 10 is not limited to the sequential execution of Steps (1) to (3). For example, Step (1) may be performed after Step (2) is performed.

A cell of a power storage device which uses the packaging material 10 is produced as below. That is, two sheets of the obtained packaging materials 10 are arranged such that sealant layers 15 face each other. Alternatively, a single packaging material 10 is folded back such that surfaces of the sealant layer 15 of the single packaging material 10 face each other. Then, an electricity generating element, a tab member which is to be a terminal, and the like are provided inside, and peripheral edges of the single packaging material 10 are joined by heat sealing.

### EXAMPLES

The following description will describe the present invention in detail by Examples, but the present invention is not limited by the description below. It is to be understood that the embodiments described here and generally in this application are representative of the present invention. Similarly, these following Examples are intended to be representative of the present invention.

[Evaluation Method]

(Electrolyte Resistance)

One drop of an electrolytic solution (PURELYTE, manufactured by Ube Industries) was placed on an outer layer surface of a sample, and the sample was left to stand for 24 hours. Then, the electrolytic solution was wiped off with isopropyl alcohol. A result was marked with “A” when the outer layer surface was not altered, and a result was marked with “B” when the outer layer surface was altered.

(Scratch Resistance)

A 5 cm line was drawn on the outer layer surface of the sample with use of a pencil scratch hardness tester (No.553, manufactured by Yasuda Seiki Seisakusho). A pencil having a hardness of H was used. A result was marked with “A” when a scratch was remained, and a result was marked with “B” when no scratch was remained.

(Ease of Detection of Pinholes)

The sample was inspected for pinholes from the outer layer surface side with use of a simple surface inspection device (PLX-700, manufactured by Micro Engineering). A result was marked with “A” when a pinhole was detected, and a result was marked with “B” when no pinhole was detected.

(Insulation Properties)

An insulation resistance was measured when an electric current with a constant voltage was applied to the sample for 3 minutes, with use of an insulation assessment device (TOS9201, manufactured by Kikusui Electronics). A result was marked with “A” when an insulation resistance of not less than 99.9 GΩ was maintained, and a result was marked with “B” when an insulation resistance of not less than 99.9 GΩ was not maintained.

(Film Thickness)

The film thickness of the sample was measured with use of a micrometer (MDE-25PJ, manufactured by Mitutoyo Precision Measuring Instruments).

### EXAMPLES AND COMPARATIVE EXAMPLES

### Example 1

Tolylene diisocyanate was added to a tetrafluoroethylene-vinyl copolymer-based resin, and titanium black having an average particle size of 2μm was further added so that the titanium black was 5 mass % relative to the total solid content. In this manner, a coating liquid was obtained. The coating liquid was applied to one of the surfaces of a metal foil layer, on both of which anti-corrosion treatment layers with a thickness of 50 nm had been respectively formed by ceria sol treatment. Specifically, the coating liquid was applied to one of the both surfaces of the metal foil layer so that a dry thickness became 5 μm. Then, the coating liquid was dried in an oven. Subsequently, curing was accelerated by aging treatment at 60° C. for 7 days. Furthermore, a cast polypropylene film was bonded, with a urethane adhesive, to a surface of the metal foil layer which surface was opposite to the surface on which the coating film was formed. In this manner, a packaging material was prepared.

### Example 2

A packaging material was prepared in a manner similar to that in Example 1, except that the content of titanium black was changed to 10 mass %.

### (Example 3)

A packaging material was prepared in a manner similar to that in the Example 1, except that the content of titanium black was changed to 20 mass %.

### (Example 4)

A packaging material was prepared in a manner similar to that in the Example 1, except that the content of titanium black was changed to 30 mass %.

### (Example 5)

A packaging material was prepared in a manner similar to that in the Example 1, except that the tetrafluoroethylene-vinyl copolymer-based resin was replaced with a polyester resin and the tolylene diisocyanate was replaced with a melamine resin.

### (Example 6)

A packaging material was prepared in a manner similar to that in the Example 1, except that the tetrafluoroethylene-vinyl copolymer-based resin was replaced with polycarbonate diol and the tolylene diisocyanate was replaced with polyisocyanate.

### (Comparative Example 1)

A packaging material was prepared in a manner similar to that in the Example 1, except that, instead of applying the fluorine-based resin, a stretched polyamide film was bonded to the metal foil layer with a urethane-based adhesive.

### (Comparative Example 2)

A packaging material was prepared in a manner similar to that in the Example 1, except that no titanium black was added.

### (Comparative Example 3)

A packaging material was prepared in a manner similar to that in the Example 1, except that the content of titanium black was changed to 0.5 mass %.

(Comparative Example 4)

A packaging material was prepared in a manner similar to that in the Example 1, except that the content of added titanium black was changed to 40 mass %.

TABLE 1

| | | | Ease of | | Film |
|---|---|---|---|---|---|
| | Electrolyte | Scratch | detection of | Insulation | thickness |
| | resistance | resistance | pinholes | properties | (μm) |
| Example 1 | A | A | A | A | 88 |
| Example 2 | A | A | A | A | 87 |
| Example 3 | A | A | A | A | 85 |
| Example 4 | A | A | A | A | 88 |
| Example 5 | A | A | A | A | 86 |
| Example 6 | A | A | A | A | 87 |
| Comparative | B | B | B | B | 103 |
| Example 1 | | | | | |
| Comparative | A | B | B | A | 86 |
| Example 2 | | | | | |
| Comparative | A | B | B | A | 87 |
| Example 3 | | | | | |
| Comparative | A | A | A | B | 88 |
| Example 4 | | | | | |

As shown in Table 1, the results showed that Examples 1 to 6 each had the features of the present invention being met with the desired evaluation standards for all items of: electrolyte resistance; scratch resistance; ease of pinhole detection; and insulation properties. Furthermore, in each of Examples 1 to 6, the film thickness of the packaging material was reduced, as compared with the Comparative Example 1 in which the stretched polyamide film was used.

### REFERENCE SIGNS LIST

10: Packaging material for a power storage device (packaging material), 11: Coating layer, 12: Metal foil layer, 13: Anti-corrosion treatment layer, 14: Adhesive layer, 15: Sealant layer.

What is claimed is:

1. A packaging material for a power storage device comprising:
a metal foil layer;
a coating layer formed on a first surface of the metal foil layer;
an anti-corrosion treatment layer formed on a second surface of the metal foil layer;
an adhesive layer formed on the anti-corrosion treatment layer; and
a sealant layer formed on the adhesive layer, wherein the coating layer contains at least one material selected from a group consisting of a fluorine-based resin, a polyester resin, and a polyurethane resin, and the coating layer contains 1 to 30 mass % of a pigment.

2. The packaging material for a power storage device of claim 1, wherein the pigment is at least one material selected from a group consisting of an inorganic pigment and an organic pigment.

3. The packaging material for a power storage device of claim 1, wherein the coating layer has a thickness of 3 to 30 μm.

4. The packaging material for a power storage device of claim 1, wherein the coating layer has been cured.

5. The packaging material for a power storage device of claim 1, wherein the coating layer is formed by coating.
